(19) United States
(12) Patent Application Publication
(10) Pub. No.: US 2024/0198929 A1
(43) Pub. Date: Jun. 20, 2024

(54) Fastener Clip Assembly with Multiple Threads for Receiving a Screw

(71) Applicant: Termax Company, Lake Zurich, IL (US)

(72) Inventors: Daniel James Dickinson, Lincolnshire, IL (US); David Friesorger, McHenry, IL (US)

(73) Assignee: Termax Company, Lake Zurich, IL (US)

(21) Appl. No.: 18/518,506

(22) Filed: Nov. 23, 2023

Related U.S. Application Data
(60) Provisional application No. 63/432,644, filed on Dec. 14, 2022.

(51) Int. Cl. B60R 13/02

(52) U.S. Cl. CPC B60R 13/0206

(57) ABSTRACT

A system and method including a first leg and a second leg opposite the first leg. The first leg includes a first top portion and a first bottom portion and the second leg includes a second top portion and a second bottom portion. Also included is a a first wing extending from the first leg and a second wing extending from the second leg. In addition, two or more platforms are included coupling the first leg and the second leg near the first bottom portion and near the second bottom portion. At least two of the two or more platforms include a thread, and each of the threads is configured to receive a screw.

### A. Background

The invention relates generally to devices for fastening objects, and more particularly to a fastener clip assembly for insertion into an engagement structure, such as a vehicle chassis, a hollow substrate, a wall, a plate, or any suitable surface.

A number of devices and fasteners are currently available for fastening panels, such as body panels and automobile interior trim piece panels, to the chassis of a vehicle. As used herein, a body panel refers to, for example, any interior or exterior body panel on a vehicle, a plastic interior trim piece, door panel, headliner or any interior trim piece. Additionally, the panel may be any suitable exterior body panel, such as a fender, bumper, quarter panel or door panel. The chassis of the vehicle may include any substrate, plate, body panel, structural framework, chassis component or subcomponent, wall or any suitable object.

These conventional fastener devices provide approximately relatively equal levels of insertion and extraction force. These body panels often attach to the chassis of an automobile with a relatively high level of insertion force while providing a relatively low level of extraction force.

Fastener clips, such as two-piece fasteners (multi-piece), are known for attaching body panels to an automobile chassis. Two-piece fasteners are used so that if the panels are removed after original installation, such as to service the components in the door, they may be pulled apart so that one portion remains attached to the sheet metal while the other remains attached to the trim panel. The two pieces may also be reattached after separation. However, two-piece fasteners require manufacturing of multiple pieces and labor-intensive assembly of the two pieces and thus are relatively expensive.

One-piece fasteners are typically less expensive than two or multi piece fasteners. One-piece fasteners have a base to attach to a body panel and a post attached to the base and wings attached at least to the top of the post at a tip of the fastener for fastening to a frame slot. However, if the frame slot and the fastener are misaligned then the forces on the wings are unequal since the wing closest to the slot edge will experience higher wing compression while the other wing will have insufficient springing force to engage the slot. As the clip is forced into the slot, such high forces on one wing may cause the wing to break off thus rendering the fastener incapable of fastening the body panel to the frame. Worse, the broken, damaged or weakened wing can cause detachment of the body panel or contribute to rattles.

The wings of conventional fasteners have a sharp, unsmooth groove to engage the edge of the frame slot. When the clip is removed however, the sharp edges of the frame slot cut into the softer plastic and cut the groove. During manufacture, the slots are typically formed in the frame of the vehicle, such as in an inner roof or door sheet metal structure, by punching the sheet metal. As the punch enters the sheet metal, the outer part of the sheet metal is pushed toward the inside and a metal puncture or ridge is formed on the inside of the sheet metal. The resulting slot edge on the outer part of the slot is relatively smooth; however, the inner part of the slot edge is sharp and rough. Upon removal of the fastener clip, the sharp edges of the frame cut off the groove so that the clip may not be reinserted and reusable.

If the slot is off-center or if the sheet metal varies in thickness or if tolerances in production of the slot in the vehicle chassis or in the trim-piece exist, for example, then engagement of one portion of the hole in the chassis with one of the wings may not provide suitable frictional engagement. Twisting of the body panel will be likely more prevalent because less than all contact points are actually made with the slot of the vehicle chassis. As a result, conventional single piece fasteners do not self-align themselves when the fastener and the body panel are misaligned and are prone to wing breakage such that the fastener cannot be re-attached.

Conventional fasteners typically do not adequately secure the panel to the vehicle chassis having variations in slot size and location or sheet metal with different curvature or thicknesses throughout. Conventional single piece fasteners do not self-align themselves when the fastener and the body panel are misaligned and are prone to wing breakage such that the fastener cannot be re-attached. Also, conventional fasteners are not suitable when subjected to a variety of environmental conditions, such as in the presence of vibration at various levels of amplitude and frequency. For example, conventional fasteners of this type typically do not prevent or minimize the amount of buzzing, rattling or any other type of noise that may cause attention to the occupants of the vehicle or otherwise weaken the attachment. Conventional fasteners do not adequately accommodate various levels of production tolerances, such as various dimensions amongst, for example, the body panels as well as the vehicle chassis. Thus, conventional fastener devices typically do not self-align nor adequately fasten to a range of sheet metal thicknesses and do not minimize or eliminate buzzing and rattling and do not sufficiently accommodate variations in production tolerances. As a result, wear, squeaks, rattles, buzzing, corrosion and loss of elasticity and loss of sealing may result, especially after years of vehicle operation and exposure to vibration, heat, humidity, and other environmental conditions.

### B. Brief Description of the Drawings

Other objects and advantages of the invention may become apparent upon reading the detailed description and upon reference to the accompanying drawings.

FIG. 1 is an exploded view of a fastener clip assembly, in accordance with some embodiments.

FIG. 2 is a view of a fastener clip, in accordance with some embodiments.

FIG. 3 is an alternative view of a fastener clip, in accordance with some embodiments.

FIG. 4 is another alternative view of a fastener clip, in accordance with some embodiments.

FIG. 5 is a view of an alternative fastener clip having unevenly spaced sets of threads, in accordance with some embodiments.

FIG. 6 is an view of an alternative fastener clip having two sets of threads, in accordance with some embodiments.

FIG. 7 is a view of an assembled fastener clip attached to a first component and to a screw and a second component, in accordance with some embodiments.

FIG. 8 is another view an assembled fastener clip attached to a first component and to a screw and a second component, in accordance with some embodiments.

FIG. 9 is yet another view an assembled fastener clip attached to a first component and to a screw and a second component, in accordance with some embodiments.

While the invention is subject to various modifications and alternative forms, specific embodiments thereof are shown by way of example in the drawings and the accompanying detailed description. It should be understood, however, that the drawings and detailed description are not intended to limit the invention to the particular embodiments. This disclosure is instead intended to cover all modifications, equivalents, and alternatives falling within the scope of the present invention as defined by the appended claims.

### C. Detailed Description

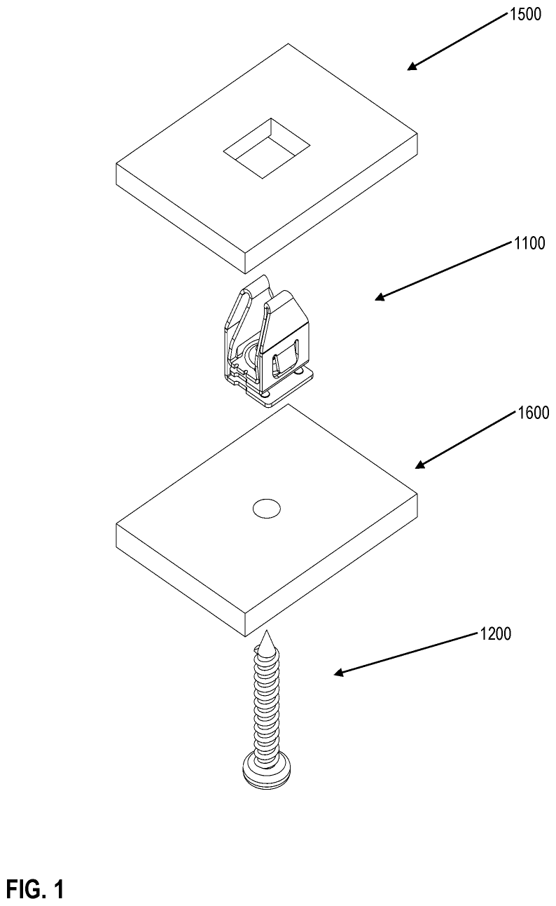

FIG. 1 is an exploded view of a fastener clip assembly, in accordance with some embodiments.

In some embodiments, the fastener clip assembly comprises high-retention fastener clip 1100 and screw 1200. Fastener clip 1100 and screw 1200 may be configured to fasten together two different components. For example, fastener clip 1100 and screw 1200 may be configured to retain various trim panels (such as second component 1600) to a vehicle chassis (such as first component 1500). It should be noted, however, that the fastener clip assembly may be configured to join various other pairs of components to each other and is not limited to fastening a panel to a chassis.

Fastener clip 1100 may be configured to be inserted into and to attach to a slot/hole in first component 1500. A second component is configured to be attached to first component 1500 using a screw that is configured to be screwed into and attach to fastener clip 1100.

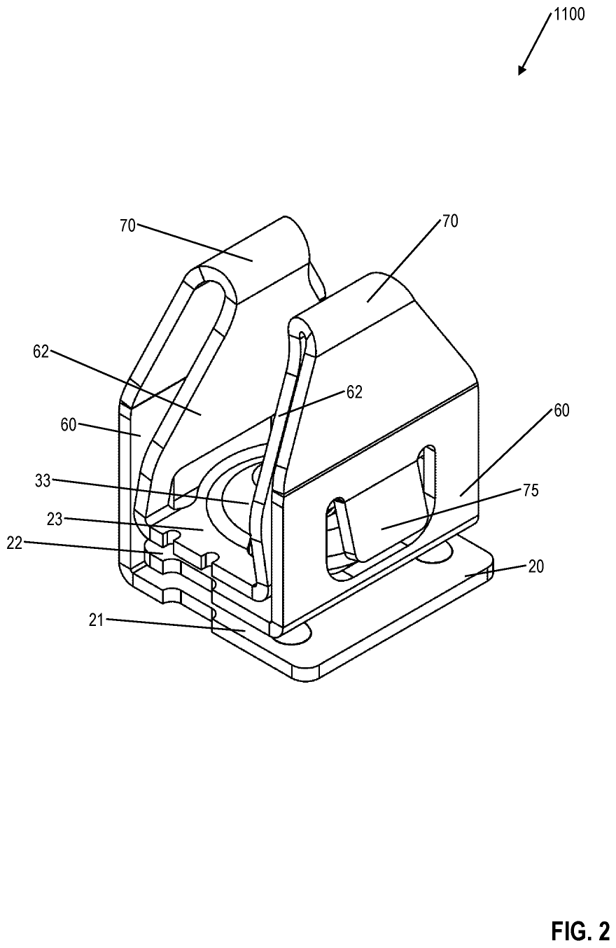

FIG. 2 is a view of a fastener clip, in accordance with some embodiments.

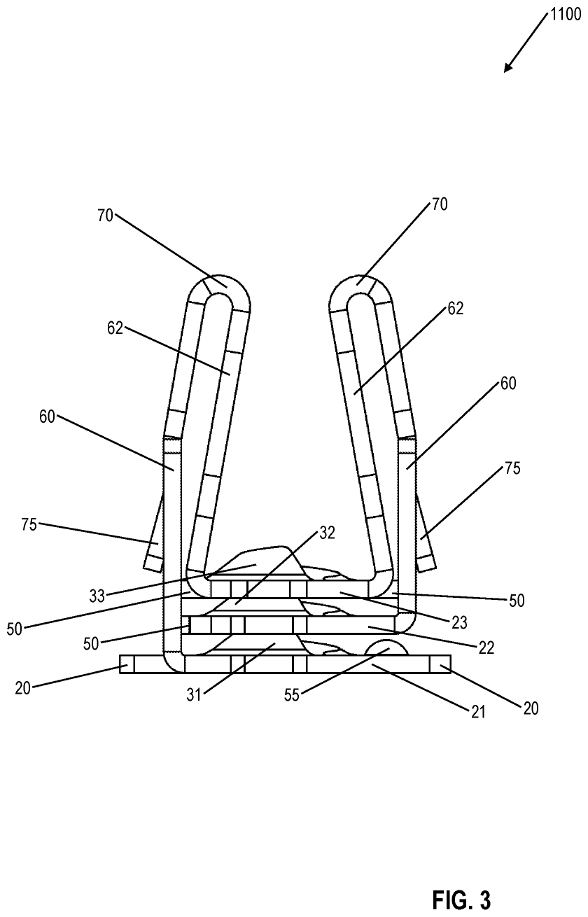

FIG. 3 is an alternative view of a fastener clip, in accordance with some embodiments.

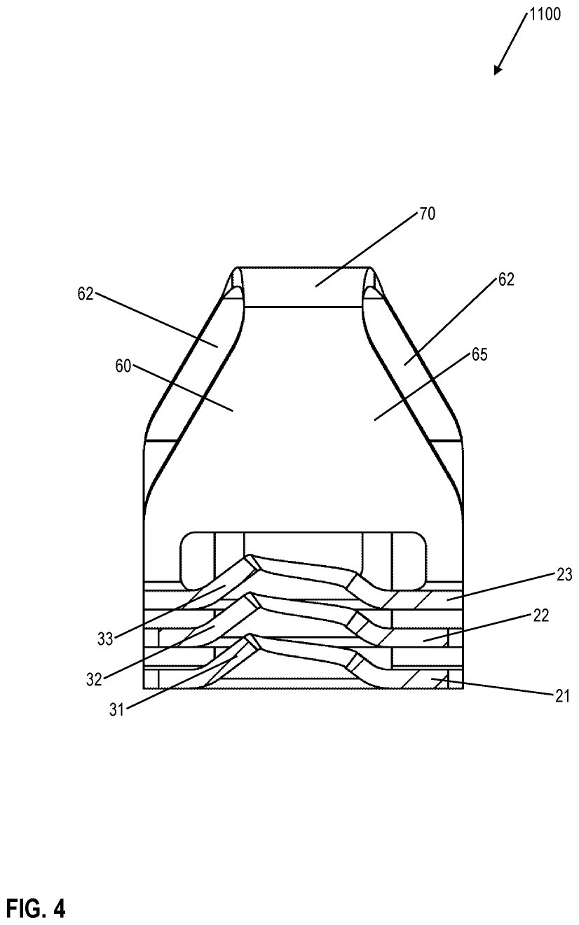

FIG. 4 is another alternative view of a fastener clip, in accordance with some embodiments.

In some embodiments, fastener clip 1100 includes a pair of outer legs (or simply legs) 60, one outer leg on each side of fastener clip 1100, and a pair of inner legs 62, one inner leg on each side of fastener clip 1100. Each outer leg is joined to one of the inner legs at first and second head portions 70: one of the inner legs to one of the outer legs at one of the head portions 70 and the other of the inner legs to the other of the outer legs at the other one of the head portions 70.

In some embodiments, pair of legs 60 taper inward as they rise respectively toward head portions 70, making fastener clip 1100 narrower at the top and easier to insert into a slot in the first component, for example.

In some embodiments, fastener clip 1100 comprises three parallel platforms 21, 22, and 23 stacked one on top of the other. In some embodiments, each of the platforms 21, 22, and 23 comprise respectively threads 31, 32, and 33, which are configured to receive a screw. In some embodiments, threads (not shown) may also be formed at the inside of inner legs 62 close to head portions 70, which are also configured to receive the screw providing additional torque tolerance for the screw.

In some embodiments, the rotational orientation of all the treads may be determined based at least upon the distances between the platforms and the distance between the platforms and the top of inner legs 62 in order for a screw with appropriate threads to be able to be screwed through threads 31, 32, and 33 and optionally through the threads at the top of the inside of legs 62 without binding.

In some embodiments, fastener clip 1100 may also include two wings 75, one on each of legs 62. In some embodiments, wings 75 are attached at their top portion and extend downward. In some embodiments, wings 75 are configured to engage a slot in a surface to which clip 1100 is configured to attach (such as an automobile chassis). Wings 75 (as well as legs 60 in some embodiments) are configured to bend inward as the clip is pushed into the slot and then spring back outward for a bottom of wings 75 to engage the slot on the first component.

In some embodiments, fastener clip 1100 may also include feet 20. Feet 20 are configured to rest against a first component to which fastener clip engages, providing a stopping point for fastener clip 1100.

In some embodiments, fastener clip 1100 may be made of metal, for strength and elasticity, for example. In some embodiments, fastener clip 1100 may be made from one continuous piece of long and mostly rectangular flat piece of metal that is appropriately punched, stamped, and/or bent to form the features of fastener clip 1100. In some embodiments, platform 21 may be formed first at one end of the metal piece followed by one of the outer legs 60, one of the inner legs 62, platform 23, the other inner leg 62, the other outer leg 60, and ending at platform 22 at the other of the metal piece.

In some embodiments, any number of platforms (and corresponding threads for each platform) may be formed depending on the torque requirements for screw 1200 for each application. For example, each platform/thread adds to the amount of torque that the screw can tolerate, and as such, a greater number of platforms/threads may be chosen for higher torque requirements. As will be seen below, only two platforms/threads may be used if less torque tolerance is required. And in embodiments where more torque tolerance is required, three or more platforms/threads may be used.

In some embodiments, supporting structures (such as tabs, bumps, etc.) may be added to better support the platforms. Additional support may be needed, for example, to handle the additional tension generated when a screw is inserted through threads 31, 32, and 33. Tabs 50, for example, may be configured to engage corresponding receiving slots in the legs, thereby increasing the force required to move the platforms relative to each other and increasing the force that each of the threads can withstand when a screw is inserted and tightened onto fastener clip 1100. In some embodiments, for additional support, support bump 55 may be placed on platform 21 in order to support platform 22 from coming closer to platform 21 under the tension from inserting and tightening a screw into fastener clip 1100. Support bump 55 further increases the force required to move the platforms relative to each other, further increasing the force that each of the threads can withstand.

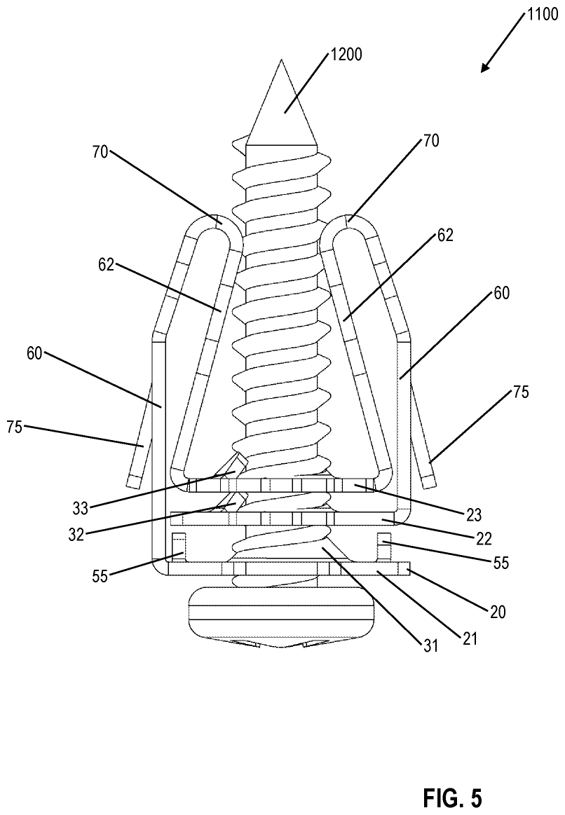

FIG. 5 is a view of an alternative fastener clip having unevenly spaced sets of threads, in accordance with some embodiments.

In some embodiments, alternative fastener clip 1100 includes a pair of outer legs (or simply legs) 60, one outer leg on each side of fastener clip 1100, and a pair of inner legs 62, one inner leg on each side of fastener clip 1100. The two pairs of legs are joined at first and second head portions 70: one of the inner legs to one of the outer legs at one of the head portions 70 and the other of the inner legs to the other of the outer legs at the other one of the head portions 70.

In some embodiments, pair of legs 60 taper inward as they rise respectively toward head portions 70, making fastener clip 1100 narrower at the top and easier to insert to a slot in a first component, for example.

In some embodiments, fastener clip 1100 comprises three platforms 21, 22, and 23 stacked one on top of the other with platform 21 toward the bottom of fastener clip 1100. In some embodiments, each of the platforms 21, 22, and 23 comprise respectively threads 31, 32, and 33, which are configured to receive a screw. In some embodiments, threads (not shown) may also be formed to the inner of inner legs 62 close to head portions 70, which are also configured to receive a screw.

In some embodiments, the pitch of all the treads may be formed based at least upon the distances between the platforms and the distance between the platforms and the top of inner legs 62 in order to for a screw with appropriate threads to be able to be screwed through threads 31, 32, and 33 and optionally through the threads at the top of the inner of legs 62 without and binding.

In the embodiments shown in FIG. 5, the distance between platform 21 and platform 22 is approximately twice the distance between platform 22 and platform 23. As such, thread 31 may be rotated 180 degrees compared to thread 32 and thread 33 in order for screw 1200 to fit through all the threads without binding.

In some embodiments, fastener clip 1100 may also include two wings 75, one on each of legs 62. In some embodiments, wings 75 are attached at their top portion and extend downward. In some embodiments, wings 75 are configured to engage a slot in a surface to which clip 1100 is configured to attach (such as a first component). Wings 75 as well as legs 60 are configured to bend inward as the clip is pushed into the slot and then spring back outward, thereby a bottom of wings 75 engaging the slot on the chassis.

In some embodiments, fastener clip 1100 may also include feet 20. Feet 20 are configured to rest against a chassis to which fastener clip engages, providing a stopping point for fastener clip 1100.

In some embodiments, supporting structures (such as tabs, bumps, etc.) may be added to better support the platforms. Additional support may be needed, for example, to handle the additional tension generated when a screw is inserted through threads 31, 32, and 33. In some embodiments, for additional support, support bumps 55 may be placed on platform 21 in order to support platform 22 from coming closer to platform 21 under the tension from inserting and tightening a screw into fastener clip 1100. Support bump 55 further increases the force required to move the platforms relative to each other, further increasing the force that each of the threads can withstand.

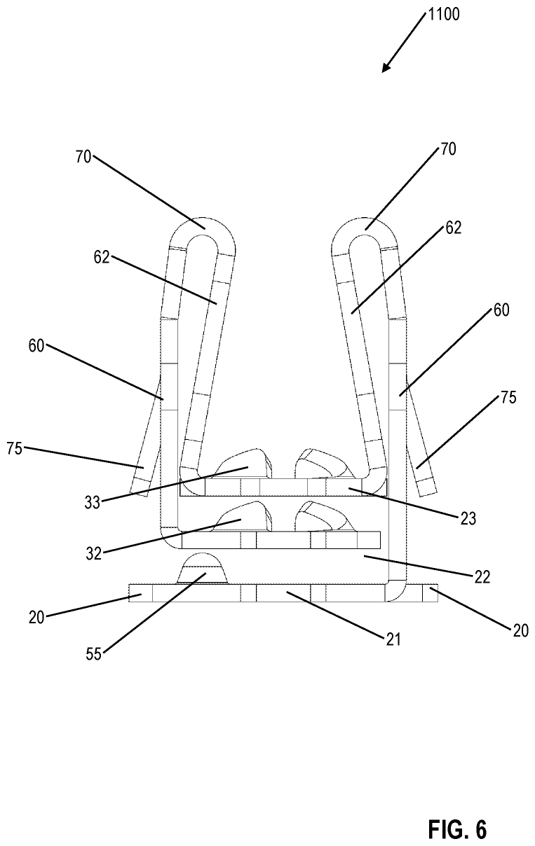

FIG. 6 is an view of an alternative fastener clip having two sets of threads, in accordance with some embodiments.

In some embodiments, alternative fastener clip 1100 includes a pair of outer legs (or simply legs) 60, one outer leg on each side of fastener clip 1100, and a pair of inner legs 62, one inner leg on each side of fastener clip 1100. The two pairs of legs are joined at first and second head portions 70: one of the inner legs to one of the outer legs at one of the head portions 70 and the other of the inner legs to the other of the outer legs at the other one of the head portions 70.

In some embodiments, pair of legs 60 taper inward as they rise respectively toward head portions 70, making fastener clip 1100 narrower at the top and easier to insert to a slot in a chassis, for example.

In some embodiments, fastener clip 1100 comprises three platforms 21, 22, and 23 stacked one on top of the other with platform 21 toward the bottom of fastener clip 1100.

In the alterative embodiment shown in FIG. 6, platforms 21 and 22 may comprise respectively threads 31 and 32, whereas platform 21 may not comprise threads. For example, such alternative fastener clip 1100 with two instead of three threads may be used in applications where torque requirements for screw 1200 are lower. In yet other embodiments, more than three platforms/threads may be used when higher torque tolerances are required.

In some embodiments, fastener clip 1100 may also include two wings 75, one on each of legs 62. In some embodiments, wings 75 are attached at their top portion and extend downward. In some embodiments, wings 75 are configured to engage a slot in a surface to which clip 1100 is configured to attach (such as an automobile chassis). Wings 75 as well as legs 60 are configured to bend inward as the clip is pushed into the slot and then spring back outward, thereby a bottom of wings 75 engaging the slot on the chassis.

In some embodiments, fastener clip 1100 may also include feet 20. Feet 20 are configured to rest against a chassis to which fastener clip engages, providing a stopping point for fastener clip 1100.

In some embodiments, supporting structures (such as tabs, bumps, etc.) may be added to better support the platforms. Additional support may be needed, for example, to handle the additional tension generated when a screw is inserted through threads 31, 32, and 33. In some embodiments, for additional support, support bump 55 may be placed on platform 21 in order to support platform 22 from coming closer to platform 21 under the tension from inserting and tightening a screw into fastener clip 1100. Support bump 55 further increases the force required to move the platforms relative to each other, further increasing the force that each of the threads can withstand.

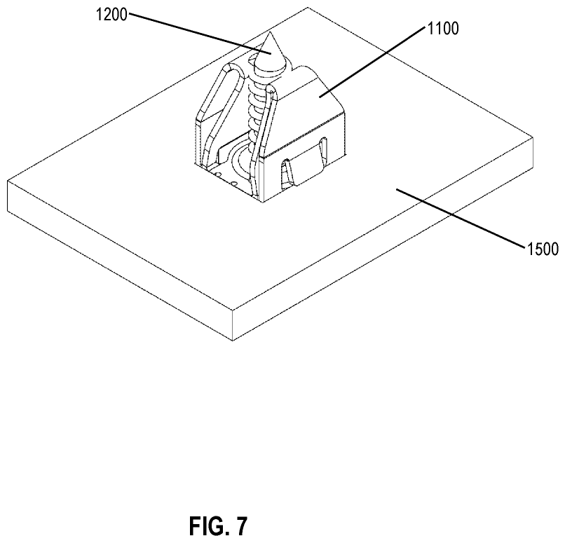

FIG. 7 is a view of an assembled fastener clip attached to a first component and to a screw, in accordance with some embodiments.

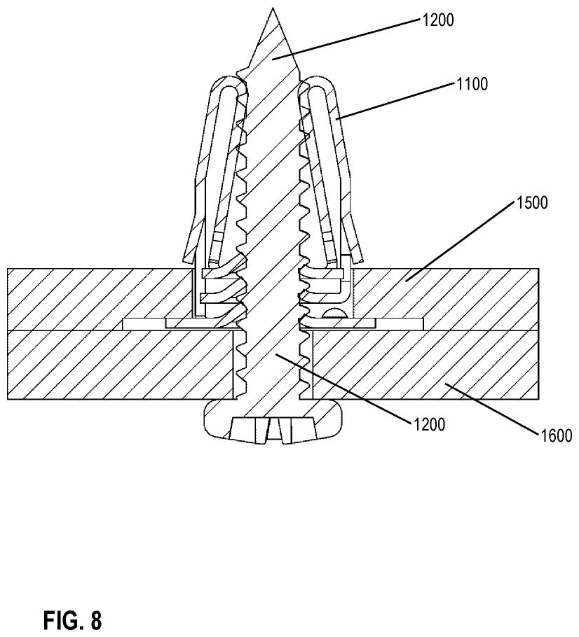

FIG. 8 is another view an assembled fastener clip attached to a first component and to a screw, in accordance with some embodiments.

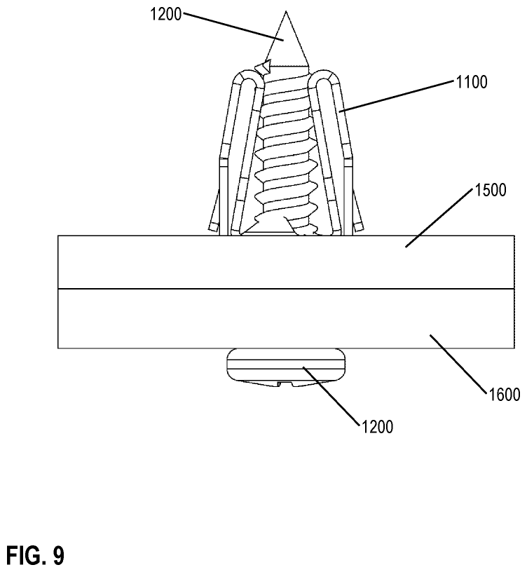

FIG. 9 is yet another view an assembled fastener clip attached to a first component and to a screw, in accordance with some embodiments.

In some embodiments, fastener clip 1100 may be configured to be attached to a slot in chassis 1500. Fastener clip 1100 is also configured to receive and couple to screw 1200. Screw 1200 may be used to attach various components, such as second component 1600, to chassis 1500.

It should be noted that, after being screwed into fastener clip 1100, screw 1200 is configured to push against the legs of fastener clip 1100 and to prevent the legs from collapsing inward. As such, this further increases the difficulty of separating fastener clip 1100 from chassis 1500, which further increases the coupling between the two.

It is understood that the implementation of other variations and modifications of the present invention in its various aspects will be apparent to those of ordinary skill in the art and that the invention is not limited by the specific embodiments described. It is therefore contemplated to cover by the present invention any and all modifications, variations or equivalents that fall within the spirit and scope of the basic underlying principles disclosed and claimed herein.

One or more embodiments of the invention are described above. It should be noted that these and any other embodiments are exemplary and are intended to be illustrative of the invention rather than limiting. While the invention is widely applicable to various types of systems, a skilled person will recognize that it is impossible to include all of the possible embodiments and contexts of the invention in this disclosure. Upon reading this disclosure, many alternative embodiments of the present invention will be apparent to persons of ordinary skill in the art.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

The benefits and advantages that may be provided by the present invention have been described above with regard to specific embodiments. These benefits and advantages, and any elements or limitations that may cause them to occur or to become more pronounced are not to be construed as critical, required, or essential features of any or all of the claims. As used herein, the terms “comprises,” “comprising,” or any other variations thereof, are intended to be interpreted as non-exclusively including the elements or limitations that follow those terms. Accordingly, a system, method, or other embodiment that comprises a set of elements is not limited to only those elements and may include other elements not expressly listed or inherent to the claimed embodiment.

While the present invention has been described with reference to particular embodiments, it should be understood that the embodiments are illustrative and that the scope of the invention is not limited to these embodiments. Many variations, modifications, additions and improvements to the embodiments described above are possible. It is contemplated that these variations, modifications, additions and improvements fall within the scope of the invention as detailed within the following claims.

1. A fastener clip assembly comprising:
a first leg and a second leg opposite the first leg, the first leg comprising a first top portion and a first bottom portion, and the second leg comprising a second top portion and a second bottom portion;
a first wing extending from the first leg and a second wing extending from the second leg;
two or more platforms coupling the first leg and the second leg near the first bottom portion and near the second bottom portion, wherein at least two of the two or more platforms comprise a thread, wherein each of the threads is configured to receive a screw.

2. The fastener clip assembly of claim 1, wherein:
the first wing and the second wing are configured to engage and to attach to a slot in a first component,
the screw is configured to couple a second component to the first component based at least on the screw being configured to be inserted through a hole in the second component and to be threaded through the threads.

3. The fastener clip assembly of claim 1, wherein a number of the threads is determined based at least on the screw's torque requirements.

4. The fastener clip assembly of claim 1, wherein a rotational orientation of each the threads is determined based at least on vertical distances between the threads.

5. The fastener clip assembly of claim 1, wherein the two or more platforms are parallel to each other.

6. The fastener clip assembly of claim 1, wherein at least some of the two or more platforms comprise at least one of support tabs and support bumps, wherein the support tabs engage corresponding receiving slots in the first leg and in the second leg to provide additional support to the two or more platforms, wherein the support bumps stop at least some of the two or more platforms from collapsing onto each other.

7. The fastener clip assembly of claim 1, further comprising feet that provide a stop as the fastener clip is being pushed into the slot in the first component.

8. The fastener clip assembly of claim 1, further comprising a first inner leg extending downward from the first top portion, and a second inner leg extending downward from the second top portion.

9. The fastener clip assembly of claim 8, further comprising leg threads formed between the first inner leg and the second inner leg near the first top portion and near the second top portion.

10. The fastener clip assembly of claim 1, wherein the first leg, the second leg, and the two or more platforms are formed from a single and continuous piece of material.

11. The fastener clip assembly of claim 10, wherein the material is a flat metal piece that is bent, punched, or stamped to form the first wing, the second wing, the two or more platforms, and the threads.
